(19) United States
(12) Patent Application Publication
(10) Pub. No.: US 2006/0188133 A1
(43) Pub. Date: Aug. 24, 2006

(54) Method of and apparatus for determing height or profile of an object

(76) Inventors: Michiel Allan Aurelius Schallig, Drachten (NL); Willem Sjouke Wijma, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,405

(22) PCT Filed: Dec. 10, 2003
(86) PCT No.: PCT/IB03/06346

§ 371 Date: Jul. 1, 2005

(30) Foreign Application Priority Data
Jan. 13, 2003 (EP) 03075074.9

(51) Int. Cl. G06K 9/00

(52) U.S. Cl. 382/128

(57) ABSTRACT

The surface profile of, or distance to, an object can be accurately determined by scanning the surface (3) with an illumination beam (2) having a slit shaped cross-section and an intensity distribution in the slit width direction (&equals; scan direction) and imaging the surface on an image sensor (5) comprising a number of pixels (51). By determining when a sensor pixel receives a maximum radiation intensity the position in the scan direction (x) of an illuminated surface area (31, 32) associated with said sensor pixel van be established and the height of this area can be measured by triangulation calculation.

The invention relates to a method of determining at least local height of an object surface by scanning an illumination radiation beam and the object surface relative to each other in a scan direction and determining the intensity of radiation reflected by the object surface by means of an image sensor comprising a number of pixels.

The invention also relates to an apparatus for carrying out the method and to a computer program product for use with the method.

Determining at least local height of an object surface is understood to cover both determining the distance between one location on the object surface and the detector and determining the profile of the object surface, i.e. determining the height at a number of locations on the object surface.

U.S. Pat. No. 5,570,186 discloses a method for inspecting the curvature of a profile by illuminating the surface with a laser beam and sensing laser light reflected by the specularly reflecting surface. The illuminating beam is divided in a number of sub-beams, the intensities of which are modulated. By determining the intensity of the laser light reflected by the specularly surface in different directions the profile of the surface is determined. This method, which is mainly suitable for measuring sharp edges, like knife-edges, requires a large number of radiation sensors. Furthermore, the position of the sensing devices used to receive the reflected laser light should be known precisely, otherwise the direction of the reflected light cannot be determined.

US-A 2002/0039187 discloses a method for determining surface shapes in which a point on a moving surface is radiated a number of times with optical radiation from a radiation direction. The optical radiation has an intensity profile with different intensities at different positions and the surface point is radiated such that radiation from different positions of the intensity profile is successively incident on the surface point. Radiation reflected by the surface is detected by an imaging device a number of times at different positions with respect to the moving surface. The movement of the point on the moving surface with respect to the intensity profile between the first and other radiation steps and the height of the surface are determined thereafter. The intensity profile has at least two different intensities and can be periodic, e.g. has a square wave or sinusoid shape, with a multiple of identical maximums.

This method requires that the position of the radiation and that of the imaging device with respect to the moving surface be determined each time reflected radiation is detected, e.g. each time an image is taken by means of the imaging device. Thus, measuring devices have to be provided to determine each time the positions of the optical radiation, the imaging device and the surface with respect to each other. Furthermore, the period of the intensity profile, i.e. the distance between the maximums, limits the maximum height difference, which can be detected since only the distance of a maximum with respect to another maximum can be determined.

It is an object of the invention to provide a more simple and accurate method of determining the profile or height of an object surface, which method does not require that for each image taken in, the position of the radiation and of the imaging device with respect to the moving surface be determined. This method is characterized by the combination of the steps of:

scanning the surface by an illumination beam having an intensity distribution showing one main maximum (MI);

determining when a sensor pixel receives a maximum radiation intensity thereby establishing the position, in the scan directions, of an illuminated surface area associated with said sensor pixel, and

measuring the distance, in a direction substantially to the scan direction, between said surface area and the image sensor.

An image sensor is a radiation-sensitive detector comprising a large number of individual sensing picture elements (pixels) and is currently used in electronic cameras.

According to the method the image sensor is stationary and each pixel of this sensor “looks” at one, point sized, area of the surface to be measured. In the plane of the surface to be measured the illumination beam has a slit like shape cross-section and shows, in the width direction of the slit, an intensity distribution with one maximum value. This beam scans the surface, which means that it will address a given area of the surface, hereinafter: the measured area. The measured area, and thus the associated sensor pixel, will receive an amount of energy, which first increases to a maximum value and then decreases. At the moment the measured area receives maximum intensity, which moment is related to a specific scanning position of the illumination beam and the surface relative to each other, the position of the measured area is known. The X- and Y-position, in the plane of the surface, of the measured area can be deduced from the X- and Y-position of the sensor pixel, which receives maximum intensity and its Z- position can be deduced from the position of the radiation source, the X-position of the measured area and the angle of incidence of the illumination beam on the surface. In this way The X-, Y- and Z-values for each point-shaped area of the surface can be determined and thus the three-dimensional profile of the surface can be established.

In contradistinction to other methods like the so-called “Lichtschnitt” method, the present method provides measurement results, which are hardly influenced by the surface condition. For example, in the Lichtschnitt method, wherein an illumination beam having a slit-like cross-section is projected on the surface, the line of gravity of the light slit is used. Variation in reflection of the surrounding surface areas influences the estimation of the position of the line of gravity. Because in the novel method a sensor pixel keeps viewing one and the same surface area and detects only the maximum of the reflected light from this area, variations in the surface conditions of neighbouring areas do not affect the measurement results.

Furthermore, the width, the shape and the sharpness of the light slit are not critical. Important is only that the slit has a maximum in its intensity across the slit width. The measurement result is not affected by variations in the surface conditions of the surface nor by variations in sensor pixel sensitivity.

The nature of the novel method allows using it for determining the distance between an object surface and a reference, for example the image sensor. The advantages of the method are most profitable employed if the method is used for measuring a surface profile.

The method is preferably further characterized in that use is made of an illumination beam having a slit shaped cross section having a width direction in the scanning direction (x) and having said intensity distribution in the width direction.

A preferred embodiment of the method is characterized in that in that use is made of an illumination beam having a Gaussian intensity distribution.

The method may be further characterized in that use is made of an illumination beam having an intensity distribution showing at least one auxiliary maximum different from the main maximum.

The method may also be characterized in that scanning is performed by moving the illumination beam (2) and the surface (3) in a direction parallel to the surface.

The invention also relates to a device for determining at least local height of an object surface measuring according to the method. This device is characterized in that it comprises:

a radiation source unit comprising a radiation source, comprising a radiation source and a member with a transparent slit, for supplying an illumination beam having a slit shaped cross-section and having, in the direction of the slit width an intensity distribution, which shows one main maximum;

means to move the radiation source unit and the surface relative to each other in plane parallel to the plane of the surface, and

an image sensor comprising a number of pixels for receiving radiation reflected from a surface region illuminated by the illumination beam;

The invention is also embedded in a computer program product for use with the method described herein above comprising program code portions for enabling a programmable device to perform steps of the method when running on said programmable device.

Specific embodiments of the method and device are set forth in the dependent claims.

These and other aspects of the invention are apparent from and will be elucidated, by way of non-limitative example with reference to the embodiments described hereinafter.

In the drawings:

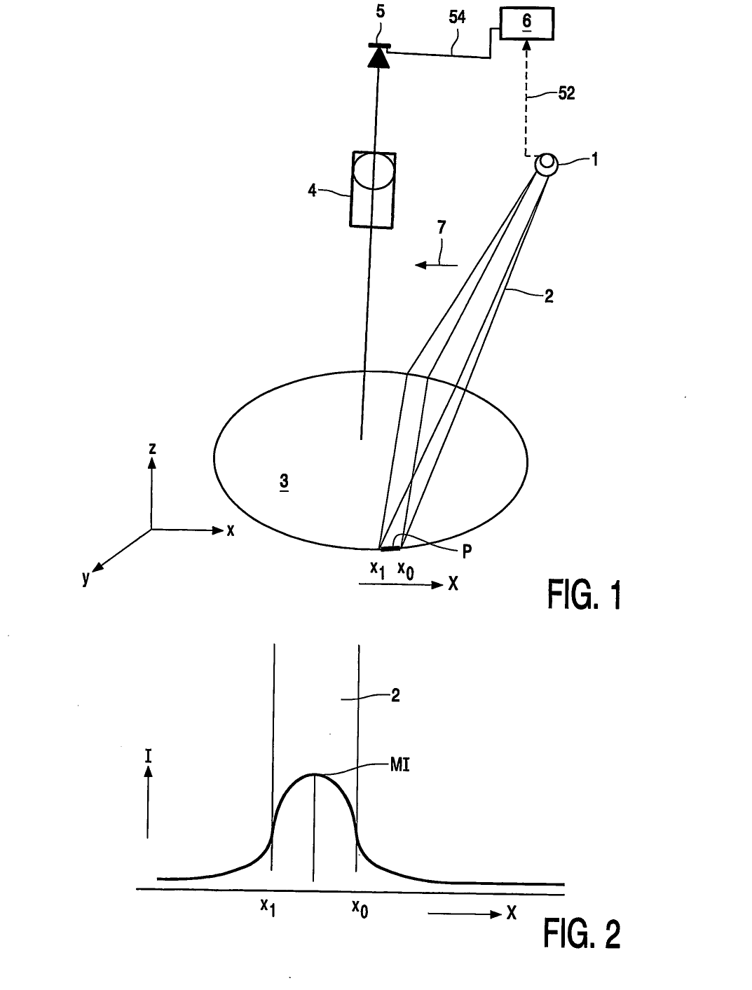

FIG. 1 shows in perspective a schematic view of an embodiment of the measuring device according to the invention;

FIG. 2 shows the intensity profile of the light beam, which can be used in this device;.

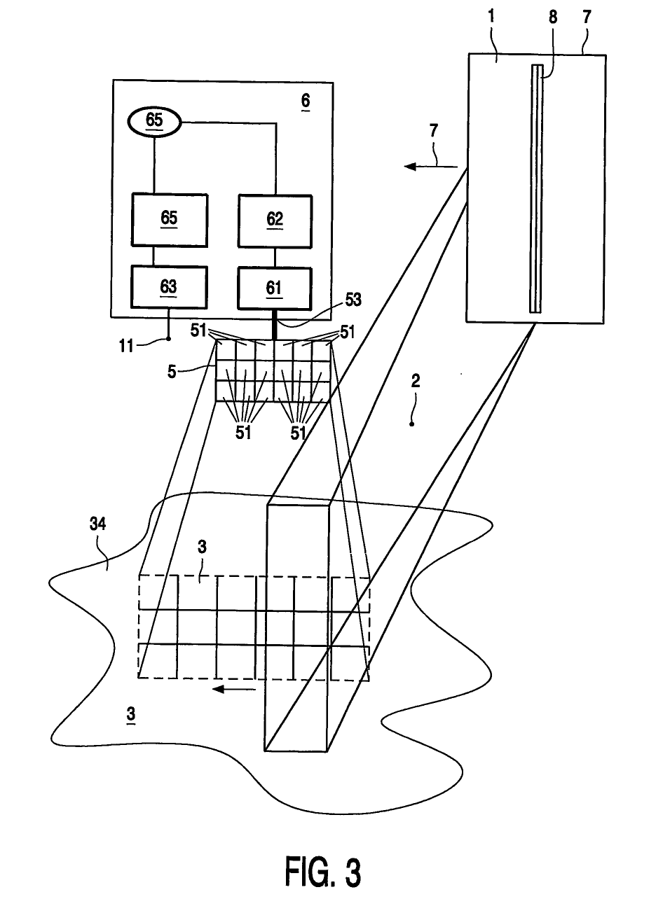

FIG. 3 shows such a device and signal processing means;

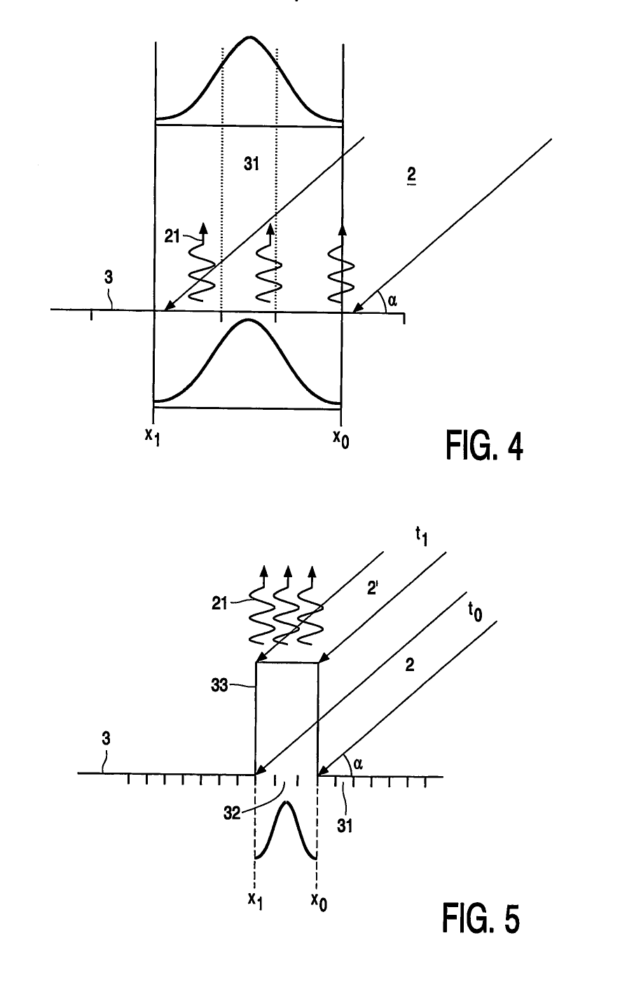

FIG. 4 shows an illumination beam incident on a flat surface portion, and

FIG. 5 shows the illumination beam incident on a bumped surface portion.

FIG. 1 shows a first embodiment of the measuring device using the method according to the invention. This device comprises a radiation source unit 1, which is very schematically represented. This source unit may include a non-transparent plate comprising a transparent slit behind which a radiation source is arranged. Between the source and the plate optical elements, for example lenses may be arranged to shape the beam from the source. The radiation source unit 1 supplies an illumination beam 2 to illuminate a portion of a surface 3 of an object (nor shown). The illumination beam 2 is movable across the surface 3. The device further comprises an optical imaging system 4, which may comprise a number of lenses, to image a portion of the surface onto an optical sensing device 5, for example an image sensor. The sensing device converts the radiation received into an electrical signal. This signal is supplied to a data processing device 6 wherein the height of the illuminated surface portion, i.e. the Z-position of this portion can be retrieved from the supplied signal. In embodiment of FIG. 1 the illumination beam 2 is incident on the surface 3 at a sharp angle.

The beam 2 illuminates a slit shaped portion of the surface 3 and has an intensity distribution in the slit width direction, i.e. the X direction in FIG. 1, which distribution comprises one main maximum. x₀ and x₁ denote the borders of the illuminated slit.

FIG. 2 shows the intensity 1 within the slit as a function of the position x. In this embodiment the main maximum, or absolute maximum MI is the only maximum. Preferably, the maximum MI is in the middle of the beam width, thus at equal distances from the borders x₀ and x₁. The intensity distribution of the illumination beam may be a Gaussian distribution, like the distribution shown in FIG. 2 or any other distribution having one main maximum, like a triangular or half of a sinusoidal distribution.

For performing a measurement of the surface the radiation source unit 1 is activated and beam 2 and the surface to be measured are moved relative to each other in the x-direction, so that successively small x portions of the surface are illuminated. Such a movement can be realized by moving the radiation source unit 1 with respect to surface in the scan direction, in this embodiment the X-direction. A sensor pixel, which views an illuminated surface area P having the size of the pixel times the magnification of the imaging system 4 receives radiation showing a time-dependent intensity variation. Namely, this intensity first increases to a maximum (the maximum MI in the slit beam moves to the area P and reaches this) and then decreases (the maximum MI leaves the area P). The detector, or image sensor, is sampled with high frequency, for example for each addressed surface area P the sensor pixel is sampled 50 to 100 times. The maximum intensity incident on the relevant surface area P and thus the maximum intensity incident on the associated sensor pixel can be determined accurately and reliable. Such maximum intensity is related to a specific position of the radiation source unit 1 with respect to the surface 3. By determining at which moment the intensity on surface area P is at the maximum value, the position of this area can be determined. The X- and Y-positions of the associated pixel give the X- and Y-position of the area P. The Z-position of this area, thus the height, can be calculated from the measured X position, the momentarily position of the radiation source unit, and the angle of incidence of the illumination beam 2 on the surface 3. Measuring the height by means of these three parameters is known per se under the name triangulation method. The angle of incidence is defined as the angle between the chief ray of the illumination beam and the normal to the surface 3.

By scanning the illumination beam 3 across the surface 3 and continuously measuring the intensity incident on the successive sensor pixels in the scan direction, the surface profile in this direction can be determined. Scanning can be performed by moving the radiation source unit 1 in the X-direction. Both the image sensor and the surface 3 are then stationary. It is also possible that the image sensor and the radiation source unit are stationary and that the surface 3 is moved in the scan direction. For scanning very accurate and reliable stages, which may be controlled by means of an interferometer and which are commercially available, may be used for the radiation source unit or the object, respectively.

For determining a two-dimensional surface profile, after a first scan and intensity measurement in the x direction across the whole surface has been finished, the surface can be moved over a small distance (stepped) in the y direction and a second scan and intensity measuring can be carried out. This can be repeated until also in the y direction the whole surface has been scanned and measured. In case the surface to be measured is a rectangular or square surface an effective use can be made of the facts that the illumination beam has a given length in the Y-direction and that the image sensor comprises a large number of pixels in this direction. By parallel processing the signals of sensor pixels at different Y positions the measuring process can be speed up. In case the object has the shape of a circle or part of it, after scanning and measuring surface areas situated along a radial line the object can be rotated and surface areas of the next radial line can be scanned and measured and so on until the whole surface has been scanned and measured.

According to the present method the topography or shape of a surface can be determined, for example by measuring a difference between an actual and an expected position of the illumination beam with respect to the surface to be measured for each portion of the surface, as is illustrated in FIGS. 4 and 5. The illumination beam 2 is incident on the surface 3 at an angle α, which is equal to 90° minus the angle of incidence. Radiation of the illumination beam is reflected by the surface 3 as a reflected light beam, for example a diffusive reflected light beam 21. An expected position of the light beam can be determined from the moment the light reflected from a surface area is expected to reach a maximum value. If, as shown in FIG. 4, the surface is flat, the illumination radiation reflected from a surface area 31 reaches a maximum at the moment the maximum of the radiation distribution of the illumination 2 is projected on that specific surface area. As the position of the sensor pixel that receives the maximum reflected radiation is known, the surface area receiving the maximum illumination radiation can be determined.

The moment a specific surface area is illuminated may also be determined by estimating the moment at which the main maximum in the intensity profile will be projected on said surface area. This estimation may, for example be based on intensities reflected by said area, and detected by the sensor pixel at other moments. In case the illumination beam has a Gaussian intensity distribution the position of the maximum on the surface or the moment at which the maximum is at a specific surface area can be determined in a relatively simple manner using known interpolation techniques. Such an interpolation can be used, for example when the maximum intensity lies between two pixels at a moment of sampling the image sensor or when the moment at which the intensity at a specific surface area reaches a maximum at a moment between two successive sampling moments.

Interpolation techniques for shapes with a single absolute maximum, for example a Gaussian shape, are generally known in the art and need not to be described here.

Furthermore several embodiments of a radiation source for supplying radiation beam having a Gaussian intensity distribution are generally known in the art, which provides a high degree of freedom in designing a device for carrying out the method.

For a non-flat surface, for example a surface having a bump 32, as shown in FIG. 5, the radiation 33 reflected from this bump 32 reaches also a maximum at the moment that the maximum in the intensity profile of the illumination beam 2 is projected on that recess. However, due to the height difference this does not occur at a moment to, as would be the case for a flat surface, but at a later moment t₁. If the position of the illumination beam 2 with respect to the surface 3 at times t₀ and t₁ or the change in position between times t₀ and t₁ is known, the height of the bump 32, with respect to the rest of the surface can be determined.

The height can be determined by means of the triangulation method, which uses the equation:
Height=displacement of beam×tan α

However, other calculations can be applied as well to determine the height, for example if not only the illumination beam is moved in a direction parallel to the surface, but also the angle of incidence is changed between moments times t₀ and t₁. Thus by determining for at least one surface the moment at which the reflected light from the area has a maximum intensity, the height of that part can be determined. As the height is determined with respect to the plane of the image sensor, also the distance between the surface area and this plane is known. As the image sensor is at a fixed position in the measuring device, this device and the method can be used for measuring the distance between this device and an object. This means that the method and the device can be used in and as a height measuring or ranging device, respectively. Properties of the measured surface, such as its absorption or reflectivity, can be determined, for example by comparing the maximum intensity of the reflected radiation with the maximum intensity MI of the illumination beam 2.

FIG. 3 shows diagrammatically an embodiment of the signal processing used in the new measuring device. This device comprises a radiation source unit 1, which is now represented by a non-transparent plate 7 comprising a transparent slit 8 behind which a radiation source (not shown) is arranged. A slit like illumination beam 2 illuminates the surface 3 to be measured. The illuminated portion of the surface is imaged by means of an imaging system (4 in FIG. 1 and not shown in FIG. 3) on an image sensor 5, which is coupled to a processing device 6. For example, the sensor 5 is arranged in a plane parallel to the main plane of the surface 3 and for imaging illumination radiation which is reflected in a direction perpendicular to the surface 3 is used. Preferably device 6 is an electronic processor having large calculation power and fast processing speed.

The image sensor comprises a large number of pixels 51arranged in a two-dimensional matrix of which only a few are shown in FIG. 3. Each pixel monitors a different surface area 35 of the surface matrix 34 of such areas an supplies an output signal that is proportional to the radiation intensity received by the pixel. These signals are supplied via a communication connection 52 to an image retrieval unit 61 of the processing device 6. The image retrieval unit 61 combines the signals from the sensor pixels 51 to obtain an image of the portion of the surface 3 that is monitored, e.g. the matrix 34 of surface areas 35 in FIG. 3. This image is stored in an image memory unit 62 of the processor device 6. Thereafter, the light beam 2 is moved along the surface, as is indicated with the arrows.

The position of the light beam 2 with respect to the surface 3 is determined each time an image of the surface is taken in, i.e. each time the sensor pixels are sampled. Preferably, the sampling frequency is high so that during movement of the illumination beam across a surface area 35, the associated pixel is sampled, for example fifty to hundred times. The novel method then makes an optimum use of the high calculating capacity of processors now available. Data representing the information about the momentarily position of the illumination beam with respect to the surface is supplied via connection 11 to a suitable receiving device 63 of the processor device 6 and stored in a data memory 64. After the desired portion of the surface has been scanned by the illumination beam 2 and the required data haven been taken in, a comparing unit 65 compares the data stored in memory 54 with the images stored in the image memory 62. The comparing unit determines at which moment the reflected light had a maximum intensity. For example in the embodiment of FIG. 3, the comparing device unit 65 determines the maximum of the reflected light for each sensor element, and thus for each surface area 35. The comparing unit 65 then retrieves from the data memory 64 the position of the light beam 2 at the moment such an maximum occurs. The comparing unit 65 also retrieves from the data memory 64 the position of the light beam 2 at a moment a maximum was expected to occur. The comparing device then determines the height of a surface area from the expected position of illumination beam 2 for which the maximum occurred and the actual position of the illumination beam, as is explained above. By performing the comparison for all the desired surface areas 35, the profile of the surface can be determined.

The comparing unit 65 may, for example, determine the expected moment of a maximum from the moments a maximum occurs in neighbouring matrix-areas. For example in the embodiment of FIG. 5, at some time before time t₀, the matrix area 31 received a maximum intensity. Thus, if the position at this time and at time t₀ is known, the expected moment, e.g. time to, the matrix-element 32 would receive maximum intensity can be determined. The element 32 receives maximum intensity at t₁ and thus the height difference between area 32 and area 31 can be determined from the difference between t₀ and t₁ and the change in position of the illumination beam.

The processing device 6 may receive data about the positions of the illumination beam or those of the radiation source unit in any manner suitable for the specific implementation. For example, the data may be provided manually via a suitable input device, such as a keyboard. The data may also be provided automatically, for example if the radiation source unit is moved in a computer controlled manner, the data can be provided via the computer controlling the movement of the source unit. It is also possible to have the movement of the source controlled by the processing device 6.

A practical embodiment of the measuring device comprises a monochrome camera provide with an 8-bit ⅓″ image sensor having 256 by 256 pixels. The camera and the objective lens of a distance microscope, forming the lens system 4, are mounted on one frame. In line with the camera and the lens system an object in the form of a shaving head is arranged. A slit shaped illumination beam with a Gaussian intensity distribution along the surface of the shaving head was generated by projecting light of a halogen lamp on a slit-shaped aperture having a width of less than 0.1 mm and preferably a width of 0.05 mm. The illumination beam is incident on the shaving head surface at an angle between 40° and 50° and preferably at an angle of 45° and this beam is moved by means of a precision positioning system, or stage. Radiation that is reflected in a direction substantially perpendicular to the surface is used for imaging the surface on the image sensor. Thus, the image sensor receives diffuse reflected radiation, whereby overexposure of the sensor pixels due to relatively high intensity specularly reflection was prevented. However, an embodiment of the method or measuring device of the invention can be implemented wherein specularly reflected radiation is sensed. In such an embodiment the position of the image sensor with respect to the surface to be measured is changed such that the image sensor receives radiation that is reflected by the surface at an angle, which is the same as the angle of incidence of the light beam.

In a method or measuring device according to the present invention, the intensity distribution of the illumination beam may be another than Gaussian. The intensity distribution may have, for example, one main maximum and no other maximums and have a triangular shape or otherwise. It is also possible to use an illumination beam having an intensity distribution, which comprises one main maximum and one or more local or auxiliary maximums which differ in intensity or otherwise from the main maximum. For example, the light beam may have an intensity profile which the shape of the function I=sin²(x)/x², and may for example be generated by diffraction, as is generally known in the art.

When the intensity profile has one or more auxiliary maximums, steps of a method according to the invention can be applied to the auxiliary maximums to increase the precision of the results obtained by means of using only a main maximum.

The image sensor or another detector in a measuring device according to the invention may be a programmable sensor or detector. The invention may also be implemented in a computer program for running on a computer system. The program includes at least code portions for performing steps of a method according to the invention when run on a computer system or enabling a general purpose computer system to perform functions of a computer system according to the invention. Such a computer program may be provided on a data carrier, such as a CD-ROM or diskette, stored with data, which can be loaded in a memory of a computer system, the data representing the computer program. The data carrier may further be a data connection, such as a telephone cable or a wireless connection transmitting signals representing a computer program according to the invention.

It should be noted that the above-mentioned embodiments illustrate rather than limit the invention, and that those skilled in the art will be able to design many alternatives without departing from the scope of the appended claims. For example, a method or device according to the invention may be used to determine a property of any type of surface, such as the shape of shaving head, turbine blades or otherwise and the invention is by no means limited to a single field of application. Also, in the example of FIG. 3, the image-retrieving unit may form part of the image sensor.

In the claims, any reference signs placed between parentheses shall not be construed as limiting the claim. The word ‘comprising’ does not exclude the presence of other elements or steps than those listed in a claim. The mere fact that certain measures are recited in mutually different claims does not indicate that a combination of these measures cannot be used to advantage.

1. A method of determining at least local height of an object surface by scanning an illumination radiation beam and the object surface relative to each other in a scan direction and determining the intensity of radiation reflected by the object surface by means of an image sensor comprising a number of pixels, characterized by the combination of the steps of:
scanning the surface by an illumination beam having an intensity distribution showing one main maximum;
determining when a sensor pixel receives a maximum radiation intensity thereby establishing the position, in the scan directions, of an illuminated surface area associated with said sensor pixel, and
measuring the distance, in a direction substantially to the scan direction, between said surface area and the image sensor.

2. A method as claimed in claim 1, characterized in that use is made of an illumination beam having a slit shaped cross section having a width direction in the scanning direction and having said intensity distribution in the width direction.

3. A method as claimed in claim 2, characterized in that use is made of an illumination beam having a Gaussian intensity distribution.

4. A method as claimed in claim 2, characterized in that use is made of an illumination beam having an intensity distribution showing at least one auxiliary maximum different from the main maximum.

5. A method as claimed in claim 1, characterized in that scanning is performed by moving the illumination beam and the surface in a direction parallel to the surface.

6. A method as claimed in claim 5, characterized in that scanning is performed by moving a radiation source unit supplying the illumination beam with respect to the surface.

7. A method as claimed in claim 1, characterized in that the height of a first surface area with respect to a second surface area is determined from the difference between a moment maximum intensity is actually detected and the moment maximum intensity is expected to occur.

8. A method as claimed in claim 1, characterized in that the moment a surface area is illuminated with maximum intensity is estimated from data obtained during illumination of other areas.

9. A method as claimed in claim 1, characterized in that use is made of diffusely reflected radiation, which is reflected in a direction substantially perpendicular to the surface.

10. A method as claimed in claim 1, characterized in that use is made of specularly reflected radiation.

11. A device for determining at least local height of an object surface measuring according to the method of claim 1, characterized in it comprises:
a radiation source unit comprising a radiation source, comprising a radiation source and a member with a transparent slit, for supplying an illumination beam having a slit shaped cross-section and having, in the direction of the slit width an intensity distribution, which shows one main maximum;
means to move the radiation source unit and the surface relative to each other in plane parallel to the plane of the surface, and
an image sensor comprising a number of pixels for receiving radiation reflected from a surface region illuminated by the illumination beam;
a data processor coupled to the image sensor, for determining when a sensor pixel receives maximum intensity thereby establishing the position of the surface area associated with said sensor pixel and for determining the height of said surface area.

12. A device as claimed in claim 11, characterized in that an optical system for imaging the surface on the image sensor is arranged between the surface and the image sensor.

13. A device as claimed in claim 11, characterized in that the image sensor is arranged in the path of diffusely reflected radiation, which radiation is reflected in a direction substantially perpendicular to the surface.

14. A device as claimed in claim 11, characterized in that the image sensor is arranged in the path of specularly reflected radiation, which is reflected at an angle with the normal to the surface substantially equal to the angle of incidence of the illumination beam on the surface.

15. A device as claimed in claim 11, characterized in that the radiation source unit comprises a halogen lamp and the slit has a width less than 0.1 mm.

16. A device as claimed in claim 11, characterized in that the angle of incidence of the illumination beam on the surface is between 30° and 60°.

17. A device as claimed in claim 11, characterized in that at least one of the image sensor and the data processor comprises at least one programmable unit.

18. A computer program product for use with the method of claim 1 and comprising program code portions for enabling a programmable device to perform steps of the method when running on said programmable device.
